(19) United States
(12) Patent Application Publication
(10) Pub. No.: US 2026/0096938 A1
(43) Pub. Date: Apr. 9, 2026

(54) PATIENT TRANSFER APPARATUS

(71) Applicant: Gerian SLOETJES, Stoney Creek (CA)

(72) Inventor: Gerian SLOETJES, Stoney Creek (CA)

(21) Appl. No.: 19/263,693

(22) Filed: Jul. 9, 2025

Related U.S. Application Data
(60) Provisional application No. 63/668,977, filed on Jul. 9, 2024.

(51) Int. Cl. A61G 1/044

(52) U.S. Cl. CPC A61G 1/044

(57) ABSTRACT

The apparatus is used with an ambulance cot having a frame and an arrangement releasably connected thereto, the arrangement including a head rest, a back rest and a base. The base extends from the backrest to a terminus. The frame is adapted to pivot the head rest and back rest with respect to the base to support the back and head of a user in elevated relation. The apparatus comprises a harness having a plurality of straps terminating in fasteners and a slider tube that has a plurality of fasteners. The slider, in use, is disposed on the arrangement, with its open ends disposed adjacent the head rest and terminus. The harness, in use, is captured beneath the arrangement, with the straps overlying the slider. The fasteners of the harness, in use, are secured to the fasteners of the slider, to secure the slider to the arrangement.

### CROSS-REFERENCE TO RELATED APPLICATIONS

This application claims priority to, and the benefit of, U.S. Provisional Patent Application Ser. No. 63/668977, filed Jul. 9, 2024, incorporated herein by reference.

### FIELD

The invention relates to the field of patient transfer.

### BACKGROUND

Workplace injuries in the field of patient transfer are unfortunately too common and improvements are desirable.

### SUMMARY

Forming one aspect of the invention is apparatus for use with a wheeled ambulance cot, the cot being of the type having a frame and a cushion arrangement releasably connected to the frame, the cushion arrangement including a head rest portion, a back rest portion and a base portion, the base portion extending from the back rest portion to a terminus, the frame being adapted to pivot the head rest portion and back rest portion with respect to the base portion to support the back and head of the user in elevated relation. This apparatus comprises a harness and a slider tube. The harness has a plurality of gripping straps terminating in fasteners.

The slider tube approximates the length and width of the cot when flat and that has a plurality of fasteners. The slider, in use, is use, is disposed on the cushion arrangement, with its ends disposed at the head rest and terminus. The harness, in use, is captured beneath the cushion arrangement, with the gripping straps overlying the slider. The fasteners of the harness, in use, are secured to the fasteners of the slider, to secure the slider to the cushion.

According to another aspect of the invention, the fasteners of the harness and the fasteners of the slider can be of the hook and loop type.

According to another aspect of the invention, the harness can be captured at least in part between the cushion arrangement and the frame in use.

Advantages, features and characteristics of the present invention will become apparent upon review of the following detailed description with reference to the appended images, the latter being briefly described hereinafter.

### BRIEF DESCRIPTION OF THE IMAGES

In the images:

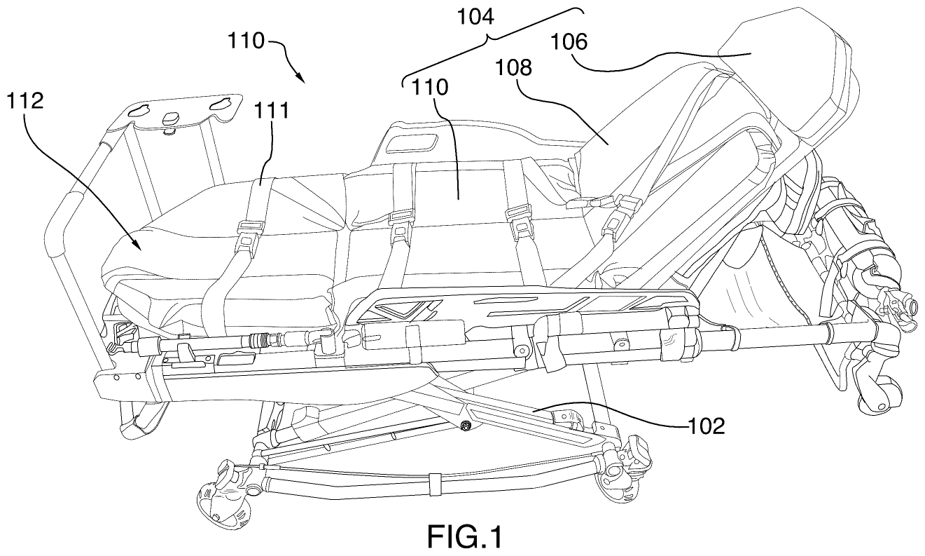

FIG. 1 is a view of a prior art wheeled ambulance cot;

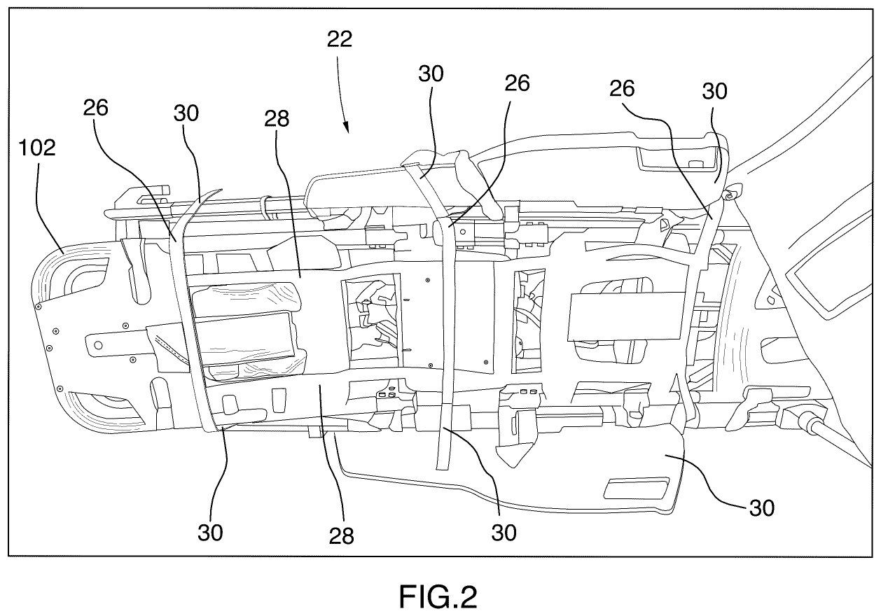

FIG. 2 is a view of the cot of FIG. 1 with the cushion removed to expose the frame and a harness according to an example embodiment of the invention installed on the frame;

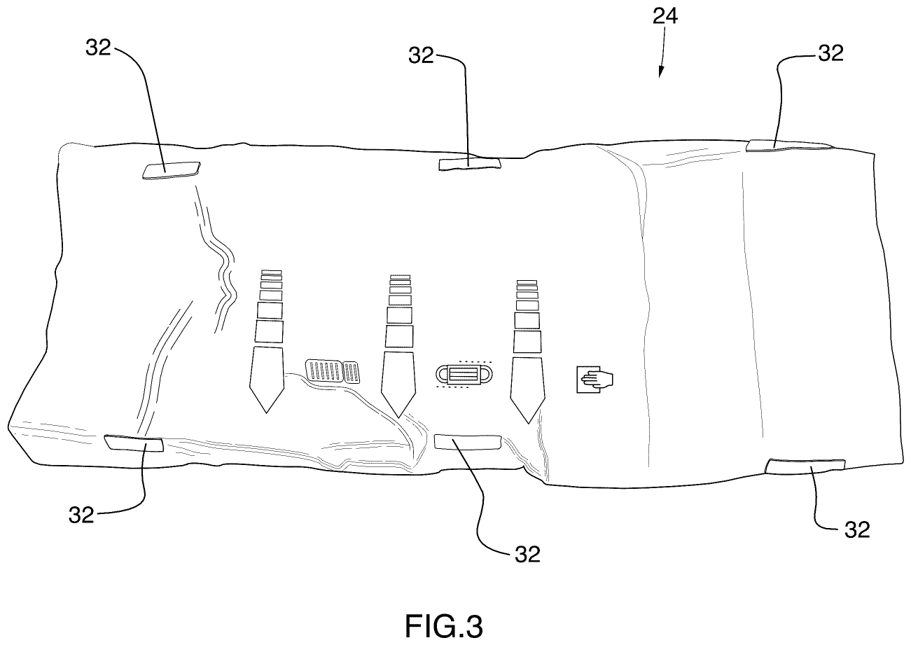

FIG. 3 is a view of a slider tube according to an example embodiment of the invention;

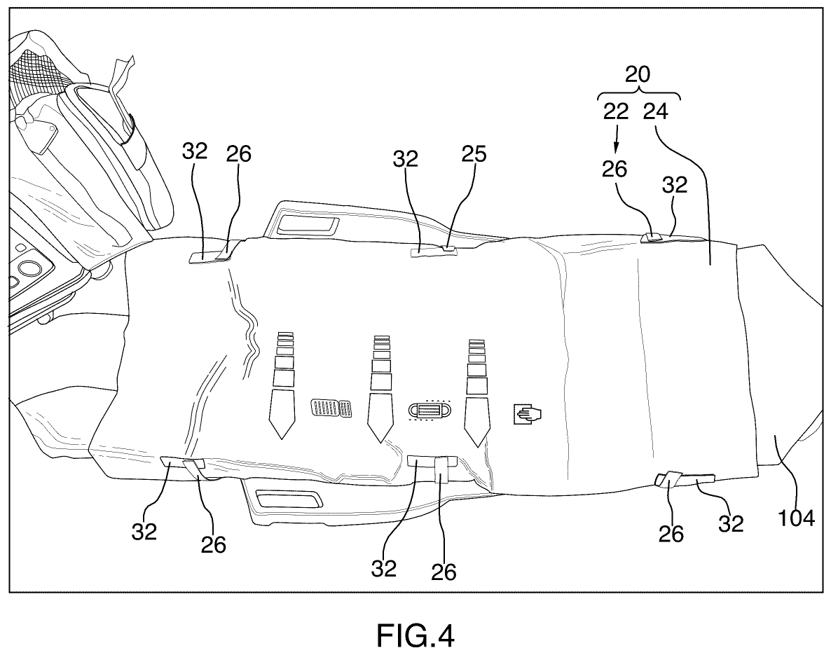

FIG. 4 is a view of the harness of FIG. 2 and slider tube of FIG. 3 in use with the cot of FIG. 1;

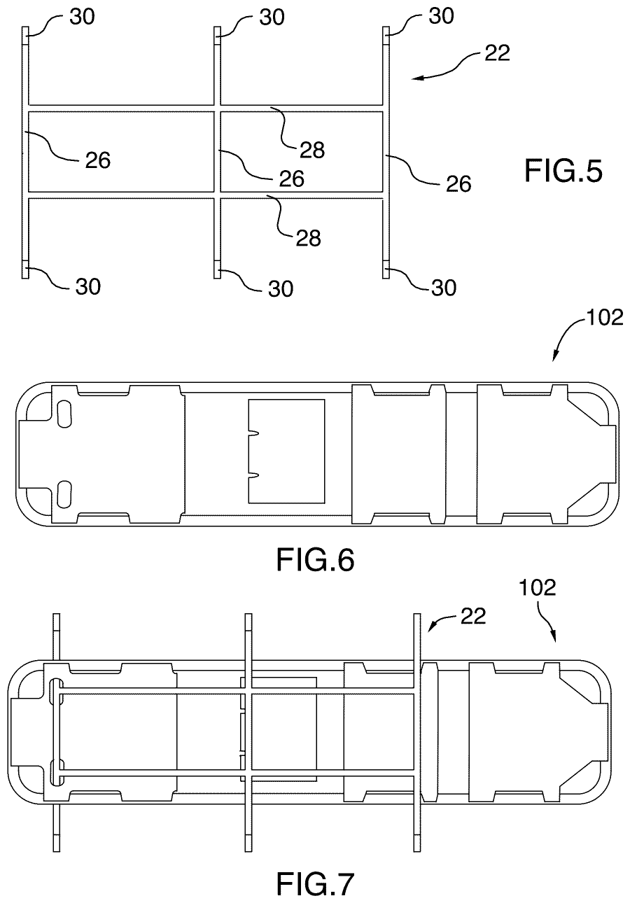

FIG. 5 is a view of the harness of FIG. 2 in isolation;

FIG. 6 is a stylized top view of a stretcher frame; and

FIG. 7 is a view of the harness of FIG. 5 in use with the structure of FIG. 6.

### DETAILED DESCRIPTION OF EMBODIMENTS

By way of introduction, the present invention pertains to the field of patient transfer and, more particularly, to the wheeled ambulance cots commonly used therefor.

A popular ambulance cot 100 is shown in FIG. 1.

This cot will be seen to be of the type having a frame 102 and a cushion arrangement 104 releasably supported by the frame 102, the cushion arrangement 104 including a head rest portion 106, a back rest portion 108 and a base portion 110, the base portion 110 extending from the back rest portion 108 to a terminus 112, the frame 102 being adapted to pivot the head rest portion 106 and back rest portion 108 with respect to the base portion 110 to support the back and head of the user in elevated relation. The cot will also be seen to have a plurality of straps 111 for securing a patient (not shown) upon the cushion arrangement.

Apparatus 20 according to an example embodiment will be seen to comprise a harness 22 and a slider 24.

The harness 22 is shown in FIG. 2 and will be seen to be a lattice of gripping straps 26 secured in spaced parallel relation to one another by a pair of alignment straps 28, the gripping straps 26 terminating in pads 30 of the hook and loop type.

The slider 24 is shown in FIG. 3 and will be seen to be a tube of fabric that functions in a manner analogous to that shown in U.S. Pat. No. 6,675,411, incorporated herein by reference, differing from the prior art in that it has a plurality of pads 32 of the hook and loop type equal in number to that number carried by the harness 22 and in that the top surface has a rubberized, anti-slip coating. By way of example only, a suitable coating is FLEX-SEAL™ All Purpose Rubberized Spray. Fabrics suitable for the construction of the tube comply with the “Reach” standard (Registration, Evaluation, Authorization and Restriction of Chemicals) and “OEKO-TEX ” for skin contact safe and environmentally friendly material.

For use, the cushion is removed from the cot to expose the frame and the harness 22 is placed upon the frame 102, as shown in FIG. 2.

Thereafter, the cushion 104 is repositioned and the slider 24 is placed upon the cushion and secured in place by the harness 22, as shown in FIG. 4.

In use, as shown in FIG. 4
the harness 22 is disposed between the frame 102 and the cushion arrangement 104 such that the gripping straps 26 are generally centered relative to the head rest and terminus and the alignment straps 28 are centered relative to the sides of the frame;
the slider 24 is disposed on the cushion 104, with its ends disposed adjacent the head rest and terminus
the pads 30 of the gripping straps 26 are secured to the pads 32 of the slider 24, thereby securing the slider 24 to the cushion arrangement 104.

This arrangement helps ensure that a slider is disposed upon the cushion arrangement when the cot reaches the patient, notwithstanding the sometimes rushed and tumultuous conditions associated with patient retrieval. Should the attendants/paramedics need the slider to transfer the patient when, for example, the hospital is reached, the gripping straps can simply be released from the slider.

As the entire assembly is relatively inexpensive and easily installed and removed, when the patient transfer is complete, the entire assembly can be removed for laundry and a fresh apparatus can be put in place.

Whereas a specific embodiment is herein described, variations are possible. One such variation is shown in the sequence of FIGS. 5-7. In these figures, it can be seen that the harness 22 can be placed generally upon the frame 102, but the straps nearest the head can pass under the frame during installation.

This helps avoid movement of the straps and slider relative to the frame. Also, whereas hook and loop fasteners are described, the fasteners could also be selected from buckle, clasp or cinch. Further variations are of course possible.

Accordingly, the invention should be understood to be limited only by the accompanying claims, purposively construed.

1. Apparatus for use with a wheeled ambulance cot, the cot being of the type having a frame and a cushion arrangement releasably connected to the frame, the cushion arrangement including a head rest portion, a back rest portion and a base portion, the base portion extending from the back rest portion to a terminus, the frame being adapted to pivot the head rest portion and back rest portion with respect to the base portion to support the back and head of the user in elevated relation, the apparatus comprising:
a harness having a plurality of gripping straps terminating in fasteners; and a slider tube that has a plurality of fasteners,
the slider, in use, being disposed on the cushion arrangement, with its open ends disposed adjacent the head rest and terminus; and
the harness, in use, being captured beneath the cushion arrangement, with the gripping straps overlying the slider,
the fasteners of the harness, in use, being secured to the fasteners of the slider, to secure the slider to the cushion.

2. Apparatus according to claim 1, wherein the fasteners of the harness and the fasteners of the slider are of the hook and loop type.

3. According to claim 1, wherein the harness is captured at least in part between the cushion arrangement and the frame in use.
